(19) United States
(12) Patent Application Publication
(10) Pub. No.: US 2025/0328982 A1
(43) Pub. Date: Oct. 23, 2025

(54) DATA PROCESSING SYSTEMS

(71) Applicant: Arm Limited, Cambridge (GB)

(72) Inventors: Mark Underwood, Cambridge (GB); Daren Croxford, Cambridge (GB); Joseph Michael Richardson, Cambridge (GB)

(73) Assignee: Arm Limited, Cambridge (GB)

(21) Appl. No.: 19/181,800

(22) Filed: Apr. 17, 2025

(30) Foreign Application Priority Data
Apr. 22, 2024 (GB) 2405606.1

(51) Int. Cl. G06T 1/20

(52) U.S. Cl. CPC G06T 1/20

(57) ABSTRACT

When performing rendering in a graphics processor that comprises plural rendering processors each operable to render one or more regions that a render output is divided into for allocation to the rendering processors, the allocation of the regions to the rendering processors is controlled based on an amount of processing expected to be required to be performed to process different ones of the regions of the render output.

### BACKGROUND

The technology described herein relates to data processing systems and, in particular, to data processing systems that allocate processing tasks to processing resources for processing, such as the allocation of regions of a render output to be rendered to rendering processors of a graphics processing system.

Many data processing systems include a plurality of processing resources (e.g. processing cores) that may each process different processing tasks in parallel to one another. This allows a larger processing task (processing job) to be split into smaller processing tasks that are submitted to different ones of the processing resources for processing, to thereby complete the processing of the larger processing task (processing job).

The technology described herein will be described with particular reference to “tile-based” graphics processing by a graphics processor that has a plurality of rendering processors, although embodiments of the technology described herein are more broadly applicable to data processing systems that issue data processing tasks to be completed to a plurality of processing resources in parallel, e.g. to process a data array.

In tile-based graphics processing, a (two dimensional) output array of a rendering process (the “render target”/“render output”) (e.g., and typically, the frame/image that will be displayed to display the scene being rendered) is sub-divided (partitioned) into a plurality of smaller regions, usually referred to as “tiles”, for the rendering process. The tiles are each rendered separately. The rendered tiles are then recombined to provide the complete output array (frame) (render target), e.g. for display.

The tiles can therefore be thought of as regions of the render target area (output frame) that the rendering process operates on. In such arrangements, the render target area (output frame) is typically divided into regularly sized and shaped tiles (they are usually, e.g., squares or rectangles) but this is not essential.

Other terms that are commonly used for “tiling” and “tile based” rendering include “chunking” (the sub-regions are referred to as “chunks”) and “bucket” rendering. The terms “tile” and “tiling” will be used herein for convenience, but it should be understood that these terms are intended to encompass all alternative and equivalent terms and techniques.

In graphics processing systems that comprise a plurality of independent rendering processors (processing (shader) cores), different tiles of a render target may be processed (rendered) in parallel by different rendering processors (cores), thereby potentially reducing the time taken to process (render) the render target. To control the rendering of different tiles by different rendering processors, the tiles may be allocated to particular respective rendering processors for processing and the rendering processors may successively render the tiles allocated to them until all of the required tiles of the render target have been rendered. Which tiles of a render output are allocated to which rendering processors may be controlled according to the availability of the respective rendering processors and a predetermined allocation order (e.g. raster path) for the tiles of the render output

The Applicants believe that there remains scope for improvements to the operation of graphics processing systems that comprise a plurality of rendering processors.

### BRIEF DESCRIPTION OF THE DRAWINGS

Embodiments of the technology described herein will now be described by way of example only and with reference to the accompanying drawings, in which:

FIG. 1 illustrates schematically an exemplary computer graphics processing system.

FIG. 2 illustrates schematically a graphics processor that is in accordance with embodiments of the technology described herein.

FIG. 3 illustrates schematically a graphics processing pipeline executed by the graphics processor in accordance with embodiments of the technology described herein.

FIG. 4 illustrates schematically a method of binning primitives to determine an amount of processing expected to be required to be performed for regions of a render output in accordance with embodiments of the technology described herein.

FIG. 5 illustrates schematically a method of determining a processing time used to process a rendering task to determine an amount of processing expected to be required to be performed for regions of a render output in accordance with embodiments of the technology described herein.

FIG. 6 illustrates schematically a method of allocating regions of a render output based on an amount of processing expected to be required to be performed for different ones of the regions of the render output in accordance with embodiments of the technology described herein.

FIG. 7 illustrates schematically a method of determining an allocation order to use to control the allocation of regions of a render output in accordance with embodiments of the technology described herein.

FIG. 8 illustrates schematically an example of a traversal path to be used when allocating regions of a render output in accordance with an embodiment of the technology described herein.

FIG. 9 illustrates schematically another example of a traversal path to be used when allocation regions of a render output in accordance with an embodiment of the technology described herein.

FIG. 10 illustrates schematically a processing timeline for the processing of two render outputs by a graphics processor in accordance with an embodiment of the technology described herein.

### DETAILED DESCRIPTION

A first embodiment of the technology described herein comprises a method of operating a graphics processor that comprises plural rendering processors each operable to render one or more regions that a render output is divided into for allocation to the rendering processors, the method comprising:
when rendering a render output that is divided into a plurality of regions for allocation to rendering processors for processing, controlling the allocation of the regions to the rendering processors based on an amount of processing expected to be required to be performed to process different ones of the regions of the render output.

A second embodiment of the technology described herein comprises a graphics processor, comprising:
a plurality of rendering processors, each operable to render one or more regions that a render output is divided into for allocation to the rendering processors;
a region allocation circuit configured to allocate regions of a render output to be processed to rendering processors for processing; and
an allocation controlling circuit configured to control the allocation of regions of the render output to the rendering processors for processing based on an amount of processing expected to be required to be performed to process different ones of the regions of the render output.

The technology described herein relates to a graphics processor that includes plural rendering processors. When processing a render output, respective regions of the render output are allocated to respective ones of the rendering processors for processing.

Processing carried out by the rendering processors for respective regions of a render output (e.g. rasterisation and shading processes) can be used to collectively render the render output, such as for display.

In the technology described herein, the allocation of regions of a render output to rendering processors for processing is controlled based on an amount of processing expected to be required to be performed to process different ones of the regions of the render output.

As will be discussed further below, the Applicants have recognised that by controlling the allocation of regions of a render output to the rendering processors for processing based on an amount of processing expected to be required to be performed to process different ones of the regions of the render output, the processing of a render output can be made more efficient.

In particular, the applicants have recognised that by controlling the allocation of regions of a render output to the rendering processors for processing based on an amount of processing expected to be required to be performed to process different ones of the regions of the render output, the amount of processing to be performed by the rendering processors can be distributed more evenly between the respective rendering processors.

This can allow the processing of a render output to be completed by the rendering processors more efficiently (and therefore can allow a render output to be made available, e.g. for display, more quickly) compared to if the amount of processing different regions of the render output are expected to require to be performed is not taken into account when allocating regions of the render output to the rendering processors for processing.

In the technology described herein, a render output may be a “final” render output (such as a frame for display), or may be an intermediate render output. For example, a render output may be the output of a draw call or render pass, and optionally there may be a plurality of intermediate draw calls that generate intermediate render outputs, with the final draw call generating the final output (frame) for display.

In the technology described herein, the regions that a render output is divided into for allocation purposes can be any suitable and desired such regions.

The regions that a render output is divided into for allocation purposes are in an embodiment based on rendering tiles that the render output (such as, e.g., a frame to be displayed) is divided into for rendering purposes, where each rendering tile should, and in an embodiment does, comprise a (respective) region (area) of the render output.

However, it is not essential that there is a direct one-to-one correspondence between the rendering tiles and the regions that the render output is divided into for allocation purposes.

In an embodiment, regions that each correspond to a whole number of one or more rendering tiles that the render output is divided into for rendering purposes are allocated to rendering processors for processing. For example, regions that the render output is divided into for allocation purposes may comprise a plurality of rendering tiles, such as a line or an array (e.g. a 2×2 array) of rendering tiles.

When a region comprising a plurality of rendering tiles is allocated to a rendering processor for processing, the rendering processor may process the region by processing the tiles in any suitable manner. For example, a rendering processor may process a region comprising a plurality of tiles in a tile-by-tile manner, where each tile is processed by the rendering processor sequentially, or may process different tiles concurrently, e.g. using different resources of the rendering processor.

The size and shape of the regions may be dictated by the tile configuration that the graphics processor is configured to use and handle.

The regions are in an embodiment all the same size and shape (i.e. regularly sized and shaped regions are in an embodiment used), although this is not essential. The regions are in an embodiment rectangular, and in an embodiment square. The size and number of regions can be selected as desired. Each region may correspond to an array of contiguous sampling positions, for example each region being 16×16 or 32×32 or 64×64 sampling positions in size. A render output may be divided into however many such regions are required to span the render output, for the size and shape of the render output that is being used.

In the technology described herein, the allocation of regions of a render output to rendering processors for processing may be controlled in any suitable manner based on an amount of processing different regions of the render output are expected to require to be performed.

In an embodiment, the graphics processor comprises rendering processors having different processing capabilities to one another, and (for at least one region of the render output, optionally for plural regions (e.g. for every region) of the render output), which rendering processor or rendering processors a region of the render output is allocated to is controlled based on an amount of processing expected to be required to be performed to process the region and on the different processing capabilities of the rendering processors.

For example, the graphics processor may comprise rendering processors having different amounts of available processing resources to one another, and the allocation of regions of the render output may be controlled such that which rendering processors different regions of the render output are allocated to is controlled based on an amount of processing expected to be required to be performed to process different ones of the regions of the render output, and on an amount of processing resources different ones of the rendering processors have available for processing the regions in question (e.g. such that a region expected to require a relatively larger amount of processing is allocated to a rendering processor having a relatively larger amount of processing resources available for processing the region, and a region expected to require a relatively smaller amount of processing is allocated to a rendering processor having a relatively smaller amount of processing resources available for processing the region).

Thus, in an embodiment, the allocation of the regions to the rendering processors is controlled (by the allocation controlling circuit) based on both:
an amount of processing expected to be required to be performed to process different ones of the regions of the render output; and
an amount of processing resources different ones of the rendering processors have available for processing one or more regions of the render output.

In an embodiment, the order in which regions of the render output are allocated to the rendering processors for processing is controlled based on an amount of processing expected to be required to be performed to process different ones of the regions of the render output.

The order in which regions of the render output are allocated to the rendering processors for processing (the allocation order for the regions) may be based in any suitable manner on an amount of processing that different ones of the regions are expected to require to be performed.

However, the allocation of regions is in an embodiment controlled so that regions expected to require relatively large amounts of processing are allocated to be processed relatively early in the allocation order of regions for the render output (before regions that are expected to require relatively small amounts of processing).

The Applicants have recognised that this may more fully utilise the rendering processors for processing a render output until the processing of that render output has been completed. In particular, avoiding regions requiring relatively large amounts of processing from needing to be allocated and processed towards the end of the allocation of the render output can allow the processing of the render output to be more evenly divided between the rendering processors up until the completion of the processing of the render output.

Thus, according to an embodiment, controlling the order in which regions of the render output are allocated to the rendering processors for processing based on an amount of processing expected to be required to be performed to process different ones of the regions of the render output comprises:
(the allocation order controlling circuit) controlling the order in which regions of the render output are allocated (by the region allocation circuit) to the rendering processors for processing such that a rendering processor (and in an embodiment each of the rendering processors) is allocated a region or regions expected to require relatively larger amounts of processing before being allocated a region or regions expected to require relatively smaller amounts of processing.

For example, in an embodiment, the regions are allocated in an order from most to least amount of processing that the regions are expected to require to be performed.

However, in other embodiments, at least some of the regions of a render output are not allocated in order from most to least amount of processing expected to be required. For example, in an embodiment, at least some of the regions of a render output are allocated based on their location within the render output.

This can allow the allocation of at least some of the regions to be based on a selected traversal path or pattern.

Thus, in an embodiment, the allocation of regions of a render output (by the region allocation circuit) to the rendering processors for processing (and in an embodiment the order in which regions of a render output are allocated) is controlled (by the allocation order controlling circuit) based on an amount of processing expected to be required to be performed to process different ones of the regions of the render output and based on the locations of the regions within the render output.

In particular, the allocation of regions is in an embodiment controlled to try and exploit potential spatial coherency between nearby regions in the render output as well as based on an amount of processing expected to be required to be performed to process different ones of the regions.

In this regard, as regions closely located to one another are typically likely to share at least some rendering state/data (e.g. textures used), allocating at least some of the regions based on their location can exploit this potential spatial coherency by a rendering processor reusing the rendering state/data for successively processed tiles, and this can be beneficial to the efficiency of the rendering process.

However, the Applicants have recognised that by using an amount of processing different regions of the render output are expected to require to be performed to control allocation of the regions in a manner described herein, the allocation can be controlled in a manner that both tries to exploit potential spatial coherency between regions as well as to try and efficiently distribute the amount of processing to be performed between the rendering processors to process the render output.

Accordingly, in an embodiment, an allocation order for regions that a render output is divided into for allocation purposes is controlled both to try and exploit potential spatial coherency between nearby regions in the render output as well as so that regions indicated to require relatively large amounts of processing are allocated to be processed relatively earlier in the allocation order.

In an embodiment, the allocation order is controlled by selecting one or more regions of the render output to allocate at the beginning and/or selecting one or more regions of the render output to allocate at the end of the allocation order, based on an amount of processing expected to be required to be performed to process different ones of the regions of the render output.

In an embodiment, controlling the order in which regions of the render output are allocated to the rendering processors for processing comprises:
selecting the region of a render output that a rendering processor is allocated to process first based on an amount of processing expected to be required to be performed to process different ones of the regions of the render output.

In an embodiment, controlling the order in which regions of a render output are allocated to the rendering processors for processing further comprises:
selecting the order in which one or more other regions of the render output (different to the region allocated to be processed first) are allocated to the rendering processors for processing based on the locations of the one or more other regions within the render output.

For example, a next region allocated to be processed may be selected based on its location within the render output and the location within the render output of one or more regions previously allocated to be processed by a rendering processor.

In an embodiment, the order in which the one or more other regions are allocated to be processed by a rendering processor is based on raster-order, Hilbert-order (“U-order”), Morton-order (“Z-order”) or Peano-order (or any other suitable path or pattern that tries to exploit spatial coherency).

In this regard, the Applicants have recognised that regions requiring relatively large amounts of processing are often located close to one another within a render output, such that by selecting a suitable starting region for a desired allocation path or pattern based on the positions of the regions requiring relatively large amounts of processing, the regions requiring relatively large amounts of processing may be allocated towards the beginning of the allocation order.

When a region of a render output that a rendering processor is selected to be allocated to process is based on an amount of processing expected to be required to be performed to process different ones of the regions of the render output, the region that that the rendering processor is allocated to process may be selected in any suitable manner based on an amount of processing expected to be required to be performed to process different ones of the regions of the render output.

In an embodiment, the region to be allocated is selected based on an amount of processing expected to be required to be performed to process that region relative to an amount of processing expected to be performed to process one or more other regions of the render output.

However, this is not essential. For example, a region that a rendering processor is allocated to process first may be selected (by the allocation controlling circuit) to be a region that results in regions expected to require relatively larger amounts of processing to be allocated to be processed relatively earlier than the other regions of the render output, without the region that the rendering processor is allocated to process first necessarily being one of the regions expected to require relatively larger amounts of processing.

For instance, the graphics processor need not necessarily be operable for any region of a render output to be able to be selected to be the region allocated to a rendering processor to process first, but may be operable such that only particular (e.g. selected ones of the) regions to be processed can be selected to be the region that is allocated to be processed first by the rendering processor (e.g. based on which of the “selectable” regions will result in regions expected to require relatively larger amounts of processing to be allocated to be processed relatively earlier in the allocation order).

For example, in an embodiment, only regions at an end of a row or column of regions of the render output may be able to be selected to be a region allocated to be processed first by a rendering processor (which can allow the control of the allocation to be simplified compared to if any region may be selected).

Furthermore, selecting a region to be allocated to process first that is not necessarily a region that is expected to require relatively larger amounts of processing (but that may be, for example, close to and/or an offset amount from regions expected to require relatively larger amounts of processing) may allow (all) of the regions expected to require relatively larger amounts of processing to be allocated to be processed relatively earlier in the allocation order while maintaining a particular path or pattern for the allocation order (e.g. that tries to increase the potential for spatial coherency).

Thus, in an embodiment, selecting the region of a render output that a rendering processor is allocated to process first based on an amount of processing expected to be required to be performed to process different ones of the regions of the render output comprises:
selecting the region of a render output that a rendering processor is allocated to process first as a region of the render output that is at a position in the render output offset from one or more regions of the render output that are expected to require a relatively large amount of processing.

For example, a region may be selected that is at a position in the render output offset by a particular, e.g. fixed, number of regions in one or more directions (e.g. offset by horizontal and vertical numbers of regions) from the one or more regions of the render output that are expected to require a relatively large amount of processing.

In another example, a region may be selected that is at a position in the render output offset by a relative proportion of the overall render output size (e.g. a fraction (such as ¼) of the horizontal and vertical size of the render output) from the one or more regions of the render output that are expected to require a relatively large amount of processing.

In another example, a region may be selected that is at a position in the render output offset by an amount based on the position of the one or more regions expected to require a relatively large amount of processing (e.g. so that the region selected to be processed first is at an end of a same row or column of regions of the render output as the one or more the regions expected to require a relatively large amount of processing).

An allocation order for regions of a render output may be set for a render output as a whole, for example where it is then determined for each successive region in the allocation order which rendering processor to allocate that region to (e.g. based on which rendering processor is first available to process the region in question).

Otherwise, different groups of regions may be selected to be allocated to different rendering processors and, for a group of regions to be processed by a respective rendering processor, the order in which regions within the group are allocated to the respective rendering processor for processing may be set accordingly.

Thus, in an embodiment, controlling the order in which regions of the render output are allocated to the rendering processors for processing comprises:
selecting different groups of regions of the render output to be allocated to different rendering processors for processing; and
for a group of regions selected to be allocated to a rendering processor for processing, selecting the order in which the regions within the group are allocated to the rendering processor for processing based on an amount of processing expected to be required to be performed to process different ones of the regions of the render output.

For example, a group of regions selected to be allocated to a rendering processor for processing may comprise contiguously located regions, such as a quadrant, row or column of regions of a render output.

In an embodiment, the allocation of regions of a render output to the rendering processors for processing is controlled for each of a plurality of, and in an embodiment all of, the rendering processors in a manner described herein (based on an amount of processing expected to be required to be performed to process different ones of the regions of the render output).

Thus, for example, controlling the order in which regions of the render output are allocated to the rendering processors for processing in an embodiment comprises:
selecting the regions of a render output that each of the rendering processors is allocated to process first based on an amount of processing expected to be required to be performed to process different ones of the regions of the render output.

In the technology described herein, an amount of processing expected to be required to be performed to process different ones of the regions of a render output can be determined in any suitable manner.

In an embodiment, the graphics processor comprises an expected processing determining circuit configured to determine an amount of processing expected to be required to be performed by the rendering processors to process different ones of the regions of a render output, and to provide an indication of an amount of processing expected to be required to be performed by the rendering processors to process the different ones of the regions of a render output to the allocation controlling circuit.

The allocation controlling circuit can in an embodiment control the region allocation circuit to allocate regions of the render output to the rendering processors for processing based on the indication of an amount of processing expected to be required to be performed to process different ones of the regions of the render output.

In an embodiment, an amount of processing expected to be required to be performed to process different ones of the regions of a render output is an estimate of an amount of processing required to be performed to process different ones of the regions.

Thus, in an embodiment, an amount of processing expected to be required to be performed to process different ones of the regions of a render output is determined by estimating (determining an estimate for) the processing required to be performed for processing different ones of the regions of the render output.

An amount of processing required to be performed to process different ones of the regions may be estimated in any suitable manner.

In an embodiment, an amount of processing required to be performed to process respective regions that a render output is divided into for allocation purposes is estimated for each of plural different ones of the regions of the render output (e.g. for every region of the render output).

In another embodiment, an amount of processing required to be performed to process respective regions that a render output is divided into for allocation purposes is estimated for different sets of regions, such that each region within a set of regions is estimated to require a same amount of processing as other regions in the set.

In an embodiment, an amount of processing expected to be required to be performed to process regions of a render output is determined relative to other regions of the render output.

In an embodiment, an amount of processing expected to be required to be performed to process different ones of the regions of a render output is determined based on commands and/or data that has been generated for the processing of the different regions by the rendering processors (in an embodiment before the allocation of the regions to the rendering processors for processing).

For example, in an embodiment, an amount of processing expected to be required to be performed to process a region of a render output is determined (in an embodiment relative to one or more other regions of the render output) based on whether particular processing steps are required to be performed to process the region (where the particular processing steps may be required for some but not all of the regions of a render output, and this may be determined from the commands and/or data prepared for the processing of the different regions by the rendering processors).

In another embodiment, an amount of processing expected to be required to be performed to process a region of a render output is determined (in an embodiment relative to one or more other regions of the render output) based on a number of commands generated for processing the region (e.g. in a shader program).

In an embodiment, an amount of processing expected to be required to be performed to process different ones of the regions of a render output is determined (by the expected processing determining circuit) based on a number of (graphics) primitives to be processed for different regions of the render output.

A number of graphics primitives to be processed for different regions of a render output can be determined any suitable manner.

In an embodiment, a number of graphics primitives to be processed for different regions of a render output is determined based on the locations of primitives that are determined when generating data structures that allow the primitives required to be processed to process respective regions (e.g. tiles) of the render output to be determined.

In this regard, the location of a primitive is in an embodiment determined when generating a data structure that indicates the primitive is defined within a respective region of a render output that the data structure corresponds to. When processing a region of a render output, a rendering processor in an embodiment determines that the primitive is to be processed to process the region based on the data structure. When the locations of primitive are determined to generate such data structures, primitives to be processed for different regions are, in an embodiment, (also) counted to determine an amount of processing expected to be required to be performed to process different regions of a render output.

Thus, in an embodiment, an amount of processing expected to be required to be performed to process different regions of a render output is determined by counting primitives to be processed for different ones of the regions of the render output when generating data structures indicating which primitives are required to be processed to process respective regions of the render output.

In an embodiment, the graphics processor comprises:
a tiling circuit configured to determine locations of primitives to generate data structures indicating which primitives are required to be processed to process respective regions of a render output;
a primitive counting circuit configured to count primitives to be processed for different regions of the render output based on the locations of primitives determined by the tiling circuit, to thereby provide a number of primitives to be processed for different ones of the regions of the render output;
and an expected processing determining circuit configured to determine an amount of processing expected to be required to be performed to process different ones of the regions of the render output based on the number of primitives to be processed for different ones of the regions of the render output.

In another embodiment, data structures generated to indicate which primitives are required to be processed to process respective regions of a render output are read to determine a number of graphics primitives to be processed for different regions of a render output, and an amount of processing expected to be required to be performed to process different regions of a render output is determined based on the determined number of primitives to be processed for different regions of the render output.

When a rendering processor is allocated a region of the render output to process, the rendering processor in an embodiment uses data structures generated by the tiling circuit to determine the primitives required to be processed to process the region (and processes the determined primitives to process the region).

The data structures can be of any suitable form that allows the primitives required to be processed to process respective regions (e.g. tiles) of the render output to be determined. For example, the data structures may be primitive lists that list primitives located (at least partially) within particular regions, or representations of bounding boxes within which primitives are located that can be used to determine whether a primitive is located within a particular region.

Regions for which the data structures are prepared may correspond directly to regions for which primitives are counted to determine an amount of processing expected to be required to be performed, and to regions the render output is divided into for allocation to the rendering processors. However, this is not essential, and a render output may be divided into different regions for one or more of these purposes.

For example, the data structures may be prepared for tiles of a render output, a region that corresponds to plural tiles may be allocated to a rendering processor for processing (in which case the rendering processor can in an embodiment determine the primitives to be processed for the region based on the data structures corresponding to each of the tiles that the region comprises), and primitives may be counted for other regions (e.g. quadrants) of the render output to indicate an amount of processing expected to be required to be performed to process the different regions that the render output is divided into for allocation to the rendering processors (where if, or to what extent, a region to be allocated falls within different regions for which primitives have been counted can in an embodiment be used to determine an amount of processing expected to be required to be performed to process the region to be allocated).

In another embodiment, an amount of processing expected to be required to be performed to process different ones of the regions of a render output is determined based on which regions are expected to represent different content (and in an embodiment content of different expected processing complexities) to one another.

In this regard, the Applicants have recognised that an amount of processing expected to be required to be performed for different regions of a render output can be estimated based on the relative complexity of content expected to be represented by the different regions, and that this may be suitably used to control the allocation of the regions. For example, regions representing “sky” in a scene to be rendered may be (at least on average) less complex than regions representing “ground” in the scene and, in embodiments at least, which regions are expected to represent which content may be determined (e.g. estimated) based on the location of the regions within the render output.

Which regions of a render output are expected to represent different content may be determined in any suitable manner.

In an embodiment, an application (e.g. running on an associated host processor) that requires graphics processing operations to be performed by the graphics processor indicates which regions of a render output are expected to represent different content to one another. In this case, the expected processing determining circuit in an embodiment determines an amount of processing expected to be required to be performed to process different regions of a render output based on an indication of which regions of a render output are expected to represent different content to one another (provided by the application).

Which regions of a render output are expected to represent different content may be based on display locations of regions within the render output.

For example, it may be determined that a particular set of regions (for example the regions in the top vertical half of the render output) is expected to require a different amount of processing relative to another particular set of regions (for example the regions in the bottom vertical half of the render output) based on different relative complexities of content expected to be represented by the different sets of regions (e.g. “sky” and “ground”).

In this example, the application in an embodiment indicates locations of content of different relative complexities (e.g. indicates that regions in the top vertical half of the render output are expected to represent content of relatively lower complexity compared to regions in the bottom vertical half of the render output), and the expected processing determining circuit in an embodiment identifies regions expected to require a different amount of processing to other regions based on the indication (e.g. the expected processing determining circuit identifies which regions are in the top and bottom vertical halves of the render output and indicates to the allocation controlling circuit that regions identified as being in the top vertical half of the render output are expected to require a relatively lower amount of processing to be performed compared to regions identified as being the bottom vertical half of the render output).

Thus, in an embodiment, an amount of processing expected to be required to be performed to process different ones of the regions of a render output is determined based on a display location of a set of regions of the render output relative to a display location of another set of regions of the render output.

In an embodiment, when a display orientation or position of a render output is relevant to an amount of processing expected to be required to be performed, the display orientation or position is taken into account when determining an amount of processing expected to be required to be performed to process different ones of the regions of the render output.

For instance, when a display of a device displaying render outputs generated by the graphics processor is rotated, the orientation of render outputs being displayed may be changed, in which case this is in an embodiment taken into account (as appropriate) when determining an amount of processing expected to be required to be performed to process a region of a render output.

For example, when an amount of processing expected to be required to be performed to process different ones of the regions of a render output is based on a display location of a particular set of regions (e.g. regions in the top vertical half of the render output), a display orientation for the render output is in an embodiment determined by the expected processing determining circuit, and the expected processing determining circuit in an embodiment determines which regions are in the particular set of regions based on the determined display orientation for the render output.

The expected processing determining circuit may determine a display orientation for a render output in any suitable manner.

In an embodiment, a display orientation is determined based on an indication provided by an application (e.g. running on an associated host processor) that requires graphics processing operations to be performed by the graphics processor. For example, the application may provide an indication (e.g. via a driver for the graphics processor) when a display orientation is changed.

Thus, in an embodiment, a display orientation for a render output is determined (by the expected processing determining circuit), and an amount of processing expected to be required to be performed to process different ones of the regions of a render output is determined based (at least in part) on a determined display orientation for the render output.

In another embodiment, an amount of processing expected to be required to be performed to process different ones of the regions of a (current) render output is determined based on an amount of processing performed (by the rendering processors) to process different regions of one or more other (previous) render outputs.

In this regard, the Applicants have recognised that an amount of processing required to be performed to process different regions of a series of render outputs (e.g. frames for display) is, in embodiments at least, often similar for different render outputs that are close to one another (e.g. consecutively) within the series of render outputs. This may be, for example, because regions representing the same location within the different render outputs often represent similar content to one another.

The Applicants have further recognised that an estimate of an amount of processing expected to be required to be performed to process different regions of a render output that is based on an amount of processing performed to process different regions of one or more previous render outputs can be suitably used when allocating regions of a current render output for processing, and that this can allow the current render output to be processed more efficiently (compared to if the allocation is not based on an estimate of an amount of processing required to be performed to process different regions of a render output).

An amount of processing expected to be required to be performed to process different regions of a (current) render output may be based on any suitable measure of an amount of processing performed (by the rendering processors) to process different regions of one or more other (previous) render outputs.

For example, in embodiments, an amount of processing performed (by the rendering processors) to process different regions of one or more other (previous) render outputs is based on a number of (graphics) primitives or a number of (graphics) fragments processed for the different regions.

In an embodiment, an amount of processing performed to process different ones of the regions of one or more other (previous) render outputs is based on an amount of processing time used to process the different regions of the one or more other (previous) render outputs.

Thus, in an embodiment, the amount of processing expected to be required to be performed to process different regions of a (current) render output is determined based on an amount of processing time used (by the rendering processors) to process different regions of one or more other (previous) render outputs.

In an embodiment, the graphics processor comprises:
one or more processing time tracking circuits configured to track an amount of processing time used to process different regions of a render output; and
an expected processing determining circuit configured to determine an amount of processing expected to be required to be performed to process different regions of a render output based on an amount of processing time tracked by the one or more processing time tracking circuits for different regions of one or more other render outputs.

In an embodiment, an amount of processing expected to be required to be performed to process different regions of a render output in a series of render outputs is determined based on an amount of processing time tracked by the processing time tracking circuit(s) for different regions of the preceding render output in the series of render outputs (such that processing times for different regions of one render output are used to determine an expected amount of processing for different regions of the next consecutive render output—e.g. in the next frame for display).

In an embodiment, an amount of processing time for different regions of (only) the preceding render output is used to determine an amount of processing expected to be required to be performed to process different regions of a (current) render output.

However, in an embodiment, an amount of processing expected to be required to be performed to process different regions of a render output in a series of render outputs is determined based on an amount of processing time tracked by the one or more processing time tracking circuits for different regions of a plurality of previous render outputs in the series of render outputs.

For example, processing times for different regions of a particular number of previous render outputs (e.g. 3 preceding render outputs) may be used to determine an expected amount of processing for different regions of the next render output.

Regions of a render output for which an amount of processing expected to be required to be performed is determined may correspond directly to regions of another render output for which processing times are determined. However, this is not essential, and an amount of processing expected to be required to be performed for regions of a render output may be determined based on a relative location and/or amount of overlap compared to region(s) in another the render output for which processing times are determined.

In an embodiment, which region or regions of the one or more other (previous) render outputs is used to determine an amount of processing expected to be required to be performed to process a region or regions of the (current) render output is based on the location of the region or regions in the one or more other (previous) render outputs and the location of the region or regions in the (current) render output.

When the (current) render output and the one or more other (previous) render outputs are part of a series of render outputs, which render output or outputs are selected as the one or more other (previous) render outputs is in an embodiment based on the position of the (current) render output in the series relative to the position of the other render output or render outputs in the series.

When a set of intermediate render outputs (e.g. where different ones of the intermediate render outputs represent different render targets) are used to produce a final render output (e.g. frame for display), in an embodiment an amount of processing expected to be required to be performed to process different regions of a (current) intermediate render output is determined based on an amount of processing time used (by the rendering processors) to process different regions of one or more other (previous) intermediate render outputs (in an embodiment representing the same render target for different frames).

When regions of a render output for which processing times are determined are of different sizes to one another, the processing times and sizes of the regions are in an embodiment taken into account when determining an amount of processing expected to be required for processing a region of another render output (for example by determining a processing time per a given unit of size).

In an embodiment, the processing times for regions (in an embodiment representing a corresponding location) in a number of previous render outputs are averaged to determine an amount of processing expected to be required to be performed to process a region of a (current) render output. Any suitable measure of an average may be used. For example, the mean value may be determined or a weighted average may be used, in an embodiment where a relatively higher weight is applied to a region of a render output that is relatively closer to the current render output (the render output whose amount of expected processing for different regions is being determined) in the series of render outputs.

In an embodiment, the expected processing determining circuit is configured to select whether to use an amount of processing time tracked for a region of a (particular) previous render output to determine an amount of processing expected to be required to be performed to process a region of a (current) render output.

For example, if it is identified that there has been a “scene change” where the content of the previous render output is distinctly dissimilar to the current render output then it may be selected not to use the previous render output to determine an amount of processing time expected to be required to be performed to process different regions of the current render output.

In an embodiment, the expected processing determining circuit is configured to compare an amount of processing time for a region of a previous render output to an amount of processing time for a region of another previous render output to determine whether to use the amount of processing time for the region of the previous render output to determine an amount of processing expected to be required to be performed for a region of a (current) render output.

For example, if the expected processing determining circuit determines that the processing times for regions (in an embodiment representing corresponding locations) in the two preceding render output are relatively dissimilar (e.g. the difference between the processing time is above a threshold value) then the expected processing determining circuit may select not to use the processing times for the regions of one or both of the two preceding render outputs to determine an amount of processing expected to be required to be performed to process a region of a current render output.

An amount of processing expected to be required to be performed to process different regions of a render output may be based on any other suitable manner of estimating the processing to be performed.

For example, an amount of processing expected to be required to be performed to process different regions of a render output is based on whether there is a bounding box for a region that dictates that part of the region is not required to be rendered (for example where the region straddles a display boundary, the portion outside of the boundary may not be required to be rendered).

An amount of processing expected to be required to be performed to process different regions of a render output may be based on any single manner of estimating the processing to be performed, or a combination of different manners of estimating the processing to be performed. For example, it may be selected which manner is most appropriate for a particular region or render output, or different manners may be used to collectively estimate the processing to be performed.

Irrespective of how of an amount of processing expected to be required to be performed to process different ones of the regions of a render output is determined, the allocation controlling circuit is in an embodiment operable to receive an indication of an amount of processing expected to be required to be performed to process different ones of the regions of a render output, and to control the allocation of regions of the render output to the rendering processors for processing based on the indication of an amount of processing expected to be required to be performed to process different ones of the regions of the render output.

An amount of processing expected to be required to be performed to process different ones of the regions of a render output can be indicated to the allocation controlling circuit in any suitable manner.

As discussed above, in an embodiment the graphics processor comprises an expected processing determining circuit configured to provide the indication to the allocation controlling circuit.

The indication may indicate an amount of processing expected to be required to be performed for each region of the render output (e.g. as a bitmap for the render output), or may indicate an amount of processing expected to be required to be performed for a particular one or more of the regions of the render output.

The indication may indicate that a particular set of regions is expected to require a different amount of processing relative to another particular set of regions.

In an embodiment, the indication indicates a region or regions of a render output expected to require the most amount of processing to be performed compared to other regions of the render output.

For example, a single region, a particular number of regions, or a proportion of the regions expected to require the most amount of processing to be performed compared to other regions of the render may be indicated, or a number of regions that are expected to require an amount of processing exceeding a particular threshold may be indicated.

The graphics processor in an embodiment comprises a region processing buffer for storing data indicating an amount of processing expected to be required to be performed to process different regions of a render output.

In an embodiment, data indicating an amount of processing expected to be required to be performed to process different ones of the regions of a render output is generated, the data indicating an amount of processing expected to be required to be performed to process different ones of the regions of a render output is stored in a (region processing) buffer, and an amount of processing expected to be required to be performed to process different ones of the regions of a render output is determined based on the data stored in the (region processing) buffer.

Data indicating an amount of processing expected to be required to be performed to process different ones of the regions of a render output may be generated (and stored in the region processing buffer) in any suitable manner.

For example, in an embodiment where an amount of processing expected to be required to be performed to process different regions of a render output is determined based on a number of primitives to be processed for different regions of the render output, a count of the primitives to be processed for a region (and in an embodiment a different count for different respective regions) of the render output may be stored in the region processing buffer and updated accordingly when one or more primitives are determined to be primitives to be processed for the region of the render output. A number of primitives to be processed for different regions of the render output can then be provided by reading out the count(s) stored in the region processing buffer (once the count is completed).

In an embodiment where an amount of processing expected to be required to be performed to process different regions of a (current) render output is determined based on an amount of processing time used (by the rendering processors) to process different regions of one or more other (previous) render outputs, an indication of an amount of processing time used to process a region or regions of the one or more other render outputs may be stored in the region processing buffer. For example, an amount of processing time may be stored for every region of a render output for which an amount of processing time is determined. In another example, an amount of processing time may be stored for a selected number of regions (e.g. only for the region requiring the most amount of processing time).

In an embodiment, the data indicating an amount of processing expected to be required to be performed to process different ones of the regions of a render output is stored in the region processing buffer as a data array.

The expected processing determining circuit can in an embodiment determine an amount of processing expected to be required to be performed to process different ones of the regions of a render output based on data stored in the region processing buffer, and provide an indication of the determined amount of processing expected to be required to be performed to process different ones of the regions of the render output to the allocation controlling circuit.

As discussed above, the order in which the region allocation circuit allocates regions of a render output to rendering processors for processing is in an embodiment controlled by the allocation controlling circuit.

The region allocation circuit may allocate a region of a render output to a rendering processor for processing by indicating to the rendering processor the region(s) that the rendering processor is allocated for processing in any suitable manner.

In an embodiment, the region allocation circuit can allocate a region to a rendering processor for processing by issuing a rendering task to the rendering processor, wherein the rendering task comprises a set of commands and/or data that the rendering processor can utilise to process the region that the rendering task corresponds to. The graphics processor can in an embodiment generate such a rendering task independent of when a rendering processor is available for processing the region that the rendering task corresponds to. A region can then be allocated to a rendering processor by issuing the rendering task corresponding to the region to a rendering processor as and when it is appropriate to do that.

The graphics processor in an embodiment comprises a rendering task generating circuit for generating rendering tasks and providing the rendering tasks to the region allocation circuit. A job controller of the graphics processor in an embodiment comprises the rendering task generating circuit. Thus, the graphics processor in an embodiment comprises a job controller that can generate a set of rendering tasks for a render output to be processed by the graphics processor, wherein different rendering tasks correspond to different regions of the render output. The region allocation circuit in an embodiment also forms part of the job controller.

In an embodiment, the graphics processor is operable so that the rendering tasks may correspond to an individual tile, a whole number of plural tiles, or to part(s) of tiles (sub-tile(s)). When a region corresponding to more than one tile is allocated to a rendering processor for processing, the rendering processor in an embodiment divides the processing it performs to process the region based on the tiles that the region corresponds to.

In an embodiment, when a rendering processor is allocated a region of a render output for processing, the rendering processor will identify each tile that the region corresponds to, and is in an embodiment configured to determine, for each tile that the region corresponds to, whether it is the entire tile or only part of the tile (a sub-tile) that the region allocated to the rendering processor corresponds to. The rendering processor can then process the region by processing each tile (or sub-tile) that the region corresponds to. For example, the rendering processor may process each tile (or sub-tile thereof) that a region corresponds to one after another, or may process different tiles in parallel with one another (e.g. by different sets of resources of the rendering processor processing different tiles or sub-tiles).

A (and each) rendering processor can process (the tiles or sub-tiles of) the regions and sub-regions it is allocated in any suitable and desired manner, and subject to any operation required for the purposes of the technology described herein, in an embodiment does this in the normal manner for the graphics processor and graphics processing system in question.

Thus, in an embodiment, a tile of a render output is processed by determining primitives to be processed for the tile and rasterising primitives for the tile to generate graphics fragments for shading (and then shading (rendering) the graphics fragments). The rendering processors accordingly in an embodiment comprise a rasterisation stage (rasterisation circuit) that operates to and is configured to rasterise primitives into graphics fragments for processing, and a fragment processing (shading) stage that processes the graphics fragments.

The rendering process may also or instead include (performing) ray-tracing or hybrid ray-tracing, if desired.

The primitives that need to be processed for a tile are in an embodiment determined (identified) based on data structures that allow the primitives required to be processed to process respective tiles of the render output to be determined.

The graphics processor accordingly in an embodiment comprises an appropriate tiler (tiling unit/circuit/stage) that generates data structures (e.g. primitive lists) that allow the primitives required to be processed to process respective tiles of the render output to be determined.

Once the tiling stage (tiling circuit) has completed the preparation of the data structures, then each tile can be processed (rasterised and rendered).

The rasterisation stage (rasterisation circuit) in an embodiment determines what sampling positions of the render output fall within a primitive (are covered by the primitive), and generates graphics fragments having appropriate positions (representing appropriate sampling positions) for rendering the primitive accordingly. Each graphics fragment may correspond to a single sampling position, or a set of plural sampling positions (e.g. 2×2 sampling positions), as desired.

The rendering stage (rendering circuit) should, and in an embodiment does, render fragments generated by the rasterisation stage/rasterisation circuit to generate rendered (fragment) data.

The rendering process performed by the rendering stage (rendering circuit) may comprise one or more fixed function rendering stages, such as texture mappers, blenders, effects units, etc.

In an embodiment, the rendering process performs one or more fragment shading operations on a fragment to derive rendered fragment data, such as colour values (e.g. red, green and blue (RGB) colour values) and an “alpha” (transparency) value, for shading each covered sampling position in the render output that that the fragment corresponds to. The fragment shading operations may involve any suitable processes for shading fragments, such as executing one or more fragment shading programs on the fragments, applying textures to the fragments, ray-tracing, etc.

Thus, in an embodiment the rendering stage (rendering circuit) comprises a fragment shader (a shader pipeline) (i.e. a programmable pipeline stage that is operable to and can be programmed to carry out fragment shading programs on fragments in order to render them).

The rendering processors should and in an embodiment do (each) comprise a tile buffer for storing rendered fragment data, such as colour and depth values associated with (the sampling positions of) fragments. In an embodiment a tile buffer comprises a plurality of buffers for storing different parts of the rendered data, such as a colour buffer for storing colour values and a depth buffer for storing depth values. The rendered data can in an embodiment be written out of the tile buffer to, for example, a frame buffer or “main” memory when appropriate to do so (e.g. once all of the rendered data for a tile has been generated).

The above describes the particular elements of the graphics processor that are involved in the operation in the manner of the technology described herein. As will be appreciated by those skilled in the art, the graphics processor can otherwise include, and in an embodiment does include, and execute, any one or one or more, and in an embodiment all, of the other processing circuits/stages that graphics processors may (normally) include.

Thus, for example, the graphics processor in an embodiment also includes one or more of, and in an embodiment plural of, and in an embodiment all of: one or more shader stages/circuits (such as a vertex shader or shaders); one or more (early and/or late) culling (e.g. depth and/or stencil) testers (culling (e.g. depth and/or stencil) test stages), a blender (blending stage), etc.

The writing out of the rendered data from the tile buffer to the output buffer (in memory) may also comprise, for example, downsampling and/or compressing the data from the tile buffer as it is written out.

Other arrangements for the graphics processing that is being executed would, of course, be possible.

The render output to be generated may comprise any render output that can be and is to be generated by a graphics processor and processing pipeline, such as a frame for display, a render-to-texture output, etc. In an embodiment, the render output is an output frame, and in an embodiment an image.

In an embodiment, the various functions of the technology described herein are carried out on a single graphics processing platform that generates and outputs the (rendered) data that is, e.g., written to a frame buffer for a display device.

The graphics processor may also be in communication with a host microprocessor, and/or with a display for displaying images based on the output of the graphics processor.

Although the embodiments of the technology described herein described above relate to graphics processing, it is believed that controlling the allocation of different regions of a data array to different processing circuits for processing based on an amount of processing expected to be required to be performed to process different ones of the regions of the data array in the manner described above for processing a render output may be novel and inventive in its own right.

Thus, a third embodiment of the technology described herein comprises a method of operating a data processor that comprises plural processing circuits each operable to process one or more regions that a data array is divided into for allocation to the processing circuits, the method comprising:
when processing a data array that is divided into a plurality of regions for allocation to processing circuits for processing, controlling the allocation of the regions to the processing circuits based on an amount of processing expected to be required to be performed to process different ones of the regions of the data array.

A fourth embodiment of the technology described herein comprises a data processor, comprising:
a plurality of processing circuits, each operable to process one or more regions that a data array is divided into for allocation to the processing circuits;
a region allocation circuit configured to allocate regions of a data array to be processed to processing circuits for processing; and
an allocation controlling circuit configured to control the allocation of regions of the data array to the processing circuits for processing based on an amount of processing expected to be required to be performed to process different ones of the regions of the data array.

The third and fourth embodiments of the technology described herein may comprise any of the optional features described above in relation to the first and second embodiments, as appropriate.

For example, in an embodiment the order in which regions of the data array are allocated to the processing circuits for processing is controlled based on an amount of processing expected to be required to be performed to process different ones of the regions of the data array.

In an embodiment, the order in which regions of the data array are allocated to the processing circuits for processing is controlled such that a processing circuit is allocated a region or regions expected to require relatively larger amounts of processing before being allocated a region or regions expected to require relatively smaller amounts of processing.

In an embodiment, the data processor comprises processing circuits having different processing capabilities to one another, and which processing circuit or processing circuits a region of the data array is allocated to is controlled based on an amount of processing expected to be required to be performed to process the region and on the different processing capabilities of the processing circuits.

In an embodiment, the allocation of regions of a data array to the processing circuits for processing is controlled based on an amount of processing expected to be required to be performed to process different ones of the regions of the data array and based on the locations of the regions within the data array.

In an embodiment, an amount of processing expected to be required to be performed to process different ones of the regions of a data array is determined (by an expected processing determining circuit of the data processor) based on commands and/or data that has been generated for the processing of the different regions by the processing circuits.

In an embodiment, an amount of processing expected to be required to be performed to process different ones of the regions of a data array is determined (by an expected processing determining circuit of the data processor) based on an amount of processing performed to process different regions of one or more other data arrays by the processing circuits.

In an embodiment, an amount of processing expected to be required to be performed to process different ones of the regions of a data array is determined (by an expected processing determining circuit of the data processor) based on an amount of processing time used to process different regions of one or more other data arrays by the processing circuits.

In an embodiment, an amount of processing expected to be required to be performed to process different ones of the regions of the data array is determined based on:
commands and/or data that has been generated for the processing of the different regions by the processing circuits; and/or
an amount of processing performed to process different regions of one or more other data arrays by the processing circuits;
   and
the order in which regions of the data array are allocated to the processing circuits for processing is controlled based on the determined amount of processing expected to be required to be performed to process different ones of the regions of the data array.

The data processor in an embodiment comprises a buffer for storing data indicating an amount of processing expected to be required to be performed to process different regions of a data array.

In an embodiment, data indicating an amount of processing expected to be required to be performed to process different ones of the regions of a data array is generated, the data indicating an amount of processing expected to be required to be performed to process different ones of the regions of a data array is stored in a buffer, and an amount of processing expected to be required to be performed to process different ones of the regions of a data array is determined based on the data stored in the buffer.

The technology described herein can be implemented in any suitable system, such as a suitably configured micro-processor based system. In some embodiments, the technology described herein is implemented in computer and/or micro-processor based system.

In embodiments, the graphics processor or data processor comprises, and/or is in communication with, one or more memories and/or memory devices that store the data described herein, and/or that store software for performing the processes described herein.

Although the embodiments of the technology described herein described above relate to a graphics processor (or data processor) comprising a plurality of rendering processors (or processing circuits), it is believed that controlling the issuing of different regions of a render output (or data array) to a (single) rendering processor (or processing circuit) for processing based on an amount of processing expected to be required to be performed to process different ones of the regions of the render output (or data array) in the manner described above for plural rendering processors (or processing circuits) may be novel and inventive in its own right.

Thus, a fifth embodiment of the technology described herein comprises a method of operating a graphics processor that comprises a rendering processor operable to render one or more regions that a render output is divided into for issuing to the rendering processor, the method comprising:
when rendering a render output that is divided into a plurality of regions for issuing to the rendering processor for processing, controlling the issuing of one or more regions to the rendering processor based on an amount of processing expected to be required to be performed to process different ones of the regions of the render output.

A sixth embodiment of the technology described herein comprises a graphics processor, comprising:
a rendering processor operable to render one or more regions that a render output is divided into for issuing to the rendering processor;
a region issuing circuit configured to issue regions of a render output to be processed to the rendering processor for processing; and
an issuing controlling circuit configured to control the issuing of one or more regions of the render output to the rendering processor for processing based on an amount of processing expected to be required to be performed to process different ones of the regions of the render output.

A seventh embodiment of the technology described herein comprises a method of operating a data processor that comprises a processing circuit operable to process one or more regions that a data array is divided into for issuing to the processing circuit, the method comprising:
when processing a data array that is divided into a plurality of regions for issuing to the processing circuit for processing, controlling the issuing of one or more regions to the processing circuit based on an amount of processing expected to be required to be performed to process different ones of the regions of the data array.

An eighth embodiment of the technology described herein comprises a data processor, comprising:
a processing circuit operable to render one or more regions that a data array is divided into for issuing to the processing circuit;
a region issuing circuit configured to issue regions of a data array to be processed to the processing circuit for processing; and
an issuing controlling circuit configured to control the issuing of one or more regions of the data array to the processing circuit for processing based on an amount of processing expected to be required to be performed to process different ones of the regions of the data array.

The fifth to eighth embodiments of the technology described herein may comprise any of the optional features described above in relation to the first to fourth embodiments, as appropriate.

For example, in an embodiment the order in which regions of the render output (or data array) are issued to the rendering processor (or processing circuit) for processing is controlled based on an amount of processing expected to be required to be performed to process different ones of the regions of the render output (or data array).

The various functions of the technology described herein can be carried out in any desired and suitable manner. For example, unless otherwise indicated, the functions of the technology described herein herein can be implemented in hardware or software, as desired. Thus, for example, unless otherwise indicated, the various functional elements, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuits of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics and/or data processor can otherwise include any one or more or all of the usual functional units, etc., that graphics and/or data processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

The present embodiments relate to computer graphics processing.

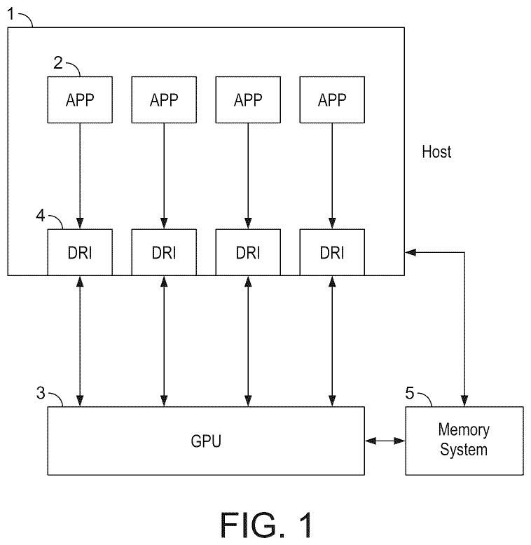

FIG. 1 shows a typical computer graphics processing system.

An application 2, such as a game, executing on a host processor (CPU) 1 will require graphics processing operations to be performed by an associated graphics processor (graphics processing unit (GPU)) 3 that executes a graphics processing pipeline. To do this, the application will generate API (Application Programming Interface) calls that are interpreted by a driver 4 for the graphics processor 3 that is running on the host processor 1 to generate appropriate commands to the graphics processor 3 to generate graphics output required by the application 2. To facilitate this, a set of “commands” will be provided to the graphics processor 3 in response to commands from the application 2 running on the host system 1 for graphics output (e.g. to generate a frame to be displayed).

As shown in FIG. 1, the graphics processing system will also include an appropriate memory system 5 for use by the host CPU 1 and graphics processor 3.

When a computer graphics image is to be rendered (e.g. and displayed), it is usually first defined as a series of primitives (polygons), which primitives are then divided (rasterised) into graphics fragments for graphics rendering in turn. During a normal graphics rendering operation, the renderer will modify the (e.g.) colour (red, green and blue, RGB) and transparency (alpha, a) data associated with each fragment so that the fragments can be displayed correctly. Once the fragments have fully traversed the renderer, their associated data values are then stored in memory, ready for output, e.g. for display.

In the present embodiments, graphics processing is carried out in a pipelined fashion, with one or more pipeline stages operating on the data to generate the final output, e.g. frame that is displayed.

The present embodiments relate to tile-based graphics processing in which tiles that a render output is divided into for rendering purposes can be processed by a rendering processor executing a graphics processing pipeline to process and output a tile separate from the processing or outputting of other tiles.

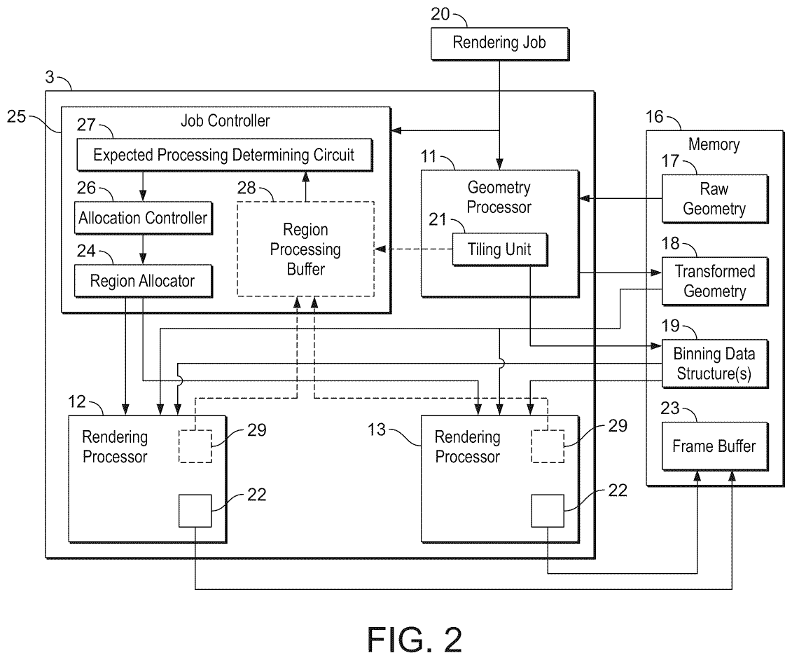

FIG. 2 shows schematically the graphics processor 3 in the embodiments. The graphics processor 3 is a tile-based graphics processor and includes a geometry processor 11 and plural rendering processors (renderers/shader cores) 12, 13, all of which can access memory 16 of the memory system 5. The memory 16 may be local to (e.g. “on-chip” with) the geometry processor 11 and rendering processors 12, 13, or may be an external memory (e.g. “main” memory) that can be accessed by the geometry processor 11 and the rendering processors 12, 13. Optionally, the graphics processor comprises one unified processor that comprises the geometry processor 11 and the rendering processors 12, 13.

FIG. 2 shows a graphics processor 3 with two rendering processors 12, 13, but other configurations of plural rendering processors can be used if desired.

The memory 16 stores, inter alia, and as shown in FIG. 2, a set of raw geometry data 17 (which is, for example, provided by a graphics processor driver 4 or an API 2 running on the host system (microprocessor) 1 for the graphics processor 3), a set of transformed geometry data 18 (which is the result of various transformation and processing operations carried out on the raw geometry 17), and a set of binning data structure(s) 19 that allow the primitives required to be processed to process respective tiles of the render output to be determined.

The binning data structure(s) 19 may, for example, comprise primitive lists that each correspond to respective regions (e.g. tile(s)) that the render output, such as a frame to be displayed, to be generated by the graphics processor 3 is divided into for rendering purposes, and contain data, commands, etc., for the respective primitives that are to be processed for the respective regions (e.g. tile(s)) that the list corresponds to.

In this case, sets of regions for which primitive lists are prepared are in an embodiment arranged in a hierarchy of sets of regions, wherein each set of regions corresponds to a layer in the hierarchy of sets of regions, and wherein regions for which primitive lists are prepared in progressively higher layers of the hierarchy are progressively larger. Each region for which a primitive list can be prepared in a lowest layer of the hierarchy in an embodiment corresponds to a single tile of the render output. Other configurations for the primitive lists would, however, be possible.

The transformed geometry data 18 comprises, for example, transformed vertices (vertex data), etc.

The geometry processor 11 takes as its input the raw geometry data 17 stored in the memory 16 in response to the graphics processor 3 receiving commands to execute a rendering job 20 from, e.g., a graphics processor driver 4, and processes that data to provide transformed geometry data 18 (which it then stores in the memory 16) comprising the geometry data in a form that is ready for placement in the render output (e.g. frame to be displayed).

The geometry processor 11 and the processes it carries out can take any suitable form and be any suitable and desired such processes. The geometry processor 11 may, e.g., include a programmable vertex shader that executes vertex shading operations to generate the desired transformed geometry data 18.

As shown in FIG. 2, the geometry processor 11 also includes a tiling unit 21. This tiling unit 21 carries out the process of preparing the binning data structure(s) 19 which is then used to identify the primitives that should be rendered for each tile that is to be rendered to generate the render output (which in this embodiment is a frame to be rendered for display). To do this, the tiling unit 21 takes as its input the transformed and processed vertex data 18 (i.e. the positions of the primitives in the render output), builds binning data structure(s) 19 using that data, and stores those binning data structure(s) as the binning data structure(s) 19 in the memory 16.

To prepare the binning data structure(s) 19, the tiling unit 21 takes each transformed primitive in turn, determines the location for that primitive, and then (if it is determined that the primitive is visible (has not been culled)) includes the primitive in the binning data structure(s) 19 in a manner that allows the region(s) that the primitive in question is determined as potentially falling within (intersecting) to be determined by reading the binning data structure(s). This may be carried out with, for example, a bounding box binning technique, or with an exact binning technique.

In the present embodiment, to process a tile or part thereof, a rendering processor takes the transformed primitives identified from the binning data structure(s) applying to the tile and rasterises and renders those primitives to, as appropriate, generate rendered graphics data in the form of output fragment (sampling point) data for each respective sampling position within the tile that it is processing. To this end, each rendering processor includes a respective rasterising unit, rendering unit and set of one or more tile buffers 22 that store the rendered data generated by the rendering processor. Once a rendering processor has completed its processing of a given tile or part thereof, the stored, rendered data for that tile or part thereof is output from the tile buffer(s) 22 to the output render target, which in this embodiment is a frame buffer 23 for a display.

As discussed above, the present embodiments relate to a tile-based graphics processor 3 comprising plural rendering processors 12, 13 in which a render output (e.g. frame to be rendered) is rendered as plural individual rendering regions that each correspond to one or more tiles or parts thereof. Thus, a respective rendering processor can render a region of the render output that it has been allocated by rendering tile(s) or parts thereof corresponding to the allocated region, and, when the rendering processor has processed a tile or part thereof within a region it is processing, write the rendered data for that tile or part thereof to the frame buffer 23. When one tile or part thereof within a region allocated to a rendering processor has been processed, another tile or part thereof (when present) within the region may be processed by the rendering processor and the rendered data for that tile or part thereof written to the frame buffer 23. When a rendering processor has finished processing one region, another region of the render output that is yet to be processed can be allocated to the rendering processor for processing. In this manner, each tile will be processed and output separately from other tiles but a respective tile may itself be output together or as separate parts (sub-tiles).

Thus, respective regions of a render output are allocated as rendering tasks to the respective rendering processors 12, 13 for processing. This operation is performed by a region allocator (region allocation circuit) 24.

In the present embodiment, the region allocator 24 is part of a job controller 25 of the graphics processor 3. The job controller 25 further comprises an allocation controller 26 that will, inter alia, issue commands and data to the region allocator 24 for the region allocator 24 to then schedule appropriate rendering tasks for and onto the graphics processing pipeline 100 of a rendering processor 12, 13. The generation of a render output by execution of a rendering job 20 is carried out by the processing of the rendering tasks. Thus, the region allocator 24 operates to allocate rendering tasks to the rendering processors 12, 13, for processing for a rendering job 20 that is to be performed by the graphics processor 3.

The job controller 25 further comprises an expected processing determining circuit 27 and, optionally, a region processing buffer 28. The region processing buffer 28 may be stored locally to other components of the job controller 25 or may be stored in external memory for use by the job controller 25 (e.g. where data is transferred from the region processing buffer to other components via a cache or caches). The expected processing determining circuit 27 can, inter alia, determine an amount of processing expected to be required to be performed by the rendering processors 12, 13 to process different ones of the regions of a render output, and provide an indication of an amount of processing expected to be required to be performed by the rendering processors 12, 13 to process different ones of the regions of a render output to the allocation controller 26. The allocation controller 26 will then control the region allocator 24 to schedule rendering tasks for and onto the graphics processing pipeline 100 of a rendering processor 12, 13 based on the indication.

The expected processing determining circuit 27 may determine an amount of processing expected to be required to be performed to process different ones of the regions of a render output based on which regions are expected to represent different content to one another.

In this case, an indication of display locations within a render output expected to represent different content may be provided with a rendering job 20, and an indication of a display orientation for the render output may be provided to the expected processing determining circuit 27, e.g. from a graphics processor driver 4. The expected processing determining circuit 27 can then determine which regions are expected to represent different content to one another based on the indication of display locations expected to represent different content and the indication of a display orientation for the render output.

The expected processing determining circuit 27 can determine an amount of processing expected to be required to be performed to process different ones of the regions of a render output based on which regions are expected to represent different content to one another, and can provide an indication of an amount of processing expected to be required to be performed to process different ones of the regions of a render output to the allocation controller 26.

The expected processing determining circuit 27 may otherwise or additionally determine an amount of processing expected to be required to be performed to process different ones of the regions of a render output based on a number of primitives to be processed for different ones of the regions of the render output.

In this case, when the tiling unit 21 determines the location of a primitive when preparing the data structure(s) 19, the region(s) that the primitive falls within are determined and the tiling unit updates a count of primitives to be processed for different respective regions of the render output stored in the processing buffer 28 accordingly, such that when the tiling unit 21 has finished determining locations of primitives for a render output, the region processing buffer 28 stores an indication of the number of primitives to be processed for different regions of the render output, and the expected processing determining circuit 27 can determine an amount of processing expected to be required to be performed to process different ones of the regions of a render output based on the data stored in the region processing buffer 28 and provide an indication of an amount of processing expected to be required to be performed to process different ones of the regions of a render output to the allocation controller 26.

The expected processing determining circuit 27 may otherwise or additionally determine an amount of processing expected to be required to be performed to process different regions of a render output based on an amount of processing time used by the rendering processors 12, 13 to process different regions of one or more other render outputs.

In this case, the rendering processors 12, 13 may each comprise a processing time tracking circuit 29 that tracks an amount of processing time that the respective rendering processor 12, 13 uses to process a region and stores an indication of an amount of processing time used to process a region of a render output in the region processing buffer 28. The expected processing determining circuit 27 can then determine an amount of processing expected to be required to be performed to process different ones of the regions of a render output based on the data stored in the region processing buffer 28 and provide an indication of an amount of processing expected to be required to be performed to process different ones of the regions of a render output to the allocation controller 26.

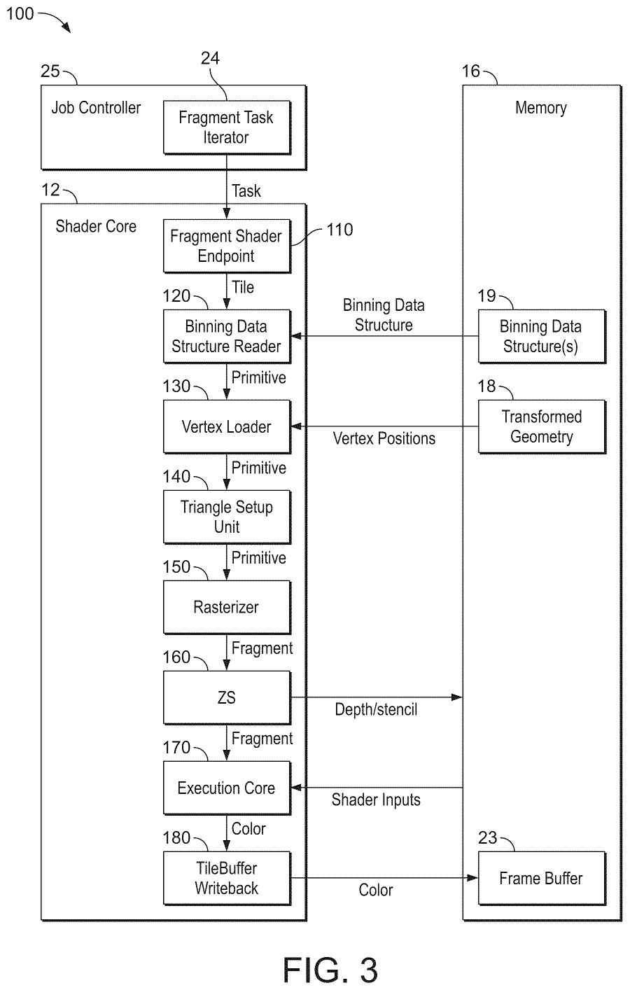

When a rendering processor 12, 13 is allocated a rendering task that corresponds to a region to be processed for a render output, the rendering processor processes that region by executing a graphics processing pipeline for the tile(s) or parts thereof that the region corresponds to. This operation of a rendering processor is described in more detail below with reference to FIG. 3.

FIG. 3 shows the job controller 25 and the stages of the graphics processing pipeline that are carried out by a rendering processor 12. The stages carried out by the rendering processor 12 are executed after the tiling unit 21 of the graphics processor 3 has prepared the required binning data structure(s) 19.

Once the tiling unit 21 has completed the preparation of the binning data structure(s) 19, then a tile of the render output can be rendered with reference to its associated binning data structure(s).

To do this, respective tiles are processed by the graphics processing pipeline stages shown in FIG. 3. A respective tile may be processed as an individual (whole) tile or as plural sub-tiles that are each processed by the graphics processing pipeline stages separately and then combined.

The region allocator (or “fragment task iterator”) 24 allocates regions to the rendering processor 12 for processing by the graphics processing pipeline 100.

The region allocator 24 may thus schedule the rendering processors 12, 13 to generate a render output, which may, e.g. be a frame to display, by the tiles being processed by the graphics processing pipeline stages of the rendering processors 12, 13.

When the rendering processor 12 is allocated a region to be processed, a fragment shader endpoint 110 of the rendering processor 12 identifies one or more tiles that the region corresponds to (e.g. at least partially intersects or is covered by).

For a given tile that all or part of is to be processed, a binning data structure reader (‘polygon reader’) 120 identifies a set of primitives to be processed for that tile based on the binning data structure(s) (e.g. based on the primitives that are listed in a primitive list for that tile), and the set of primitives for the tile is then issued into the graphics processing pipeline 100 for processing.

A vertex loader 130 then loads in the vertices for the primitives, which are then passed into a primitive set-up unit (or ‘triangle set-up unit’) 140 that operates, inter alia, to determine, from the vertices for the primitives, edge information representing the primitive edges.

When it is determined that only part of a tile (a sub-tile) is to be processed (as opposed to the whole tile), before the primitives are passed to the rasteriser 150, primitives that will not contribute to (e.g. do not fall within) the sub-tile in question are in an embodiment discarded (culled). Primitives that will not contribute to the sub-tile can thereby be prevented from being passed to the rasteriser for rasterisation.

The primitives to be rasterised are then passed to the rasteriser 150, which rasterises the primitives into respective sets of one or more sampling points and generates for the primitives individual graphics fragments having appropriate positions (representing appropriate sampling positions) for rendering the primitives.

The fragments generated by the rasteriser 150 are then sent onwards to the rest of the pipeline for processing.

For instance, in the present embodiment, the fragments generated by the rasteriser 150 are subject to (early) depth (Z)/stencil testing 160, to see if any fragments can be discarded (culled) at this stage. To do this, the Z/stencil testing stage 160 compares the depth values of (associated with) fragments issuing from the rasteriser 150 with the depth values of fragments that have already been rendered (these depth values are stored in a depth (Z) buffer that is part of the tile buffer 22) to determine whether the new fragments will be occluded by fragments that have already been rendered (or not). At the same time, an early stencil test is carried out.

Fragments that pass the fragment early Z and stencil test stage 160 may then be passed to a fragment shading stage, in the form of a shader (execution/processing) core 170, for rendering.

The fragment shading stage 170 performs the appropriate fragment processing operations on the fragments that pass the early Z and stencil tests, so as to process the fragments to generate the appropriate rendered data.

This fragment processing may include any suitable and desired fragment shading processes, such as executing fragment shader programs for the fragments, applying textures to the fragments, blending, applying effects such as fogging, or other operations to the fragments, etc., to generate the appropriate rendered data.

In the present embodiment, the fragment shading stage is in the form of a shader pipeline (a programmable fragment shader), and thus is implemented by an appropriate shader (processing/execution) core 170.

Thus, in the present embodiment, the fragment shading stage (execution core) 170 includes a programmable execution unit (engine) operable to execute fragment shader programs for respective execution threads (where each thread corresponds to one work item, e.g. an individual fragment, for the output being generated) to perform the required fragment shading operations to thereby generate rendered data. The execution unit can operate in any suitable and desired manner in this regard and comprise any suitable and desired processing circuits, etc.

Once the fragment shading is complete, the output rendered (shaded) fragment data is written to the tile buffer 22 from where it can be written out 180 to, for example, the frame buffer 23 (e.g. in the memory 16) for display. The depth value for an output fragment is also written appropriately to a Z-buffer within the tile buffer 22. (The tile buffer stores colour and depth buffers that store an appropriate colour, etc., or Z-value, respectively, for each sampling point that the buffers represent (in essence for each sampling point of a rendering tile that is being processed).) These buffers store an array of fragment data that represents part of the overall output (e.g. image to be displayed), with respective sets of sample values in the buffers corresponding to respective pixels of the overall output (e.g. each 2×2 set of sample values may correspond to an output pixel, where 4× multisampling is being used).

When a region allocated to the rendering processor 12 corresponds to all or part of more than one tile, the next tile for the region is then identified by the fragment shader endpoint 110 and is processed in the manner described above, and so on, until the processing of the region allocated to the rendering processor has been completed.

Once sufficient tiles have been processed to generate the entire render output (e.g. frame (image) to be displayed), the process can then be repeated for the next render output (e.g. frame) and so on.

For a render output that the graphics processor 3 generates, the graphics processor 3 will, in accordance with embodiments of the technology described herein, control the allocation of regions of the render output to the rendering processors 12, 13 based on an amount of processing expected to be required to be performed to process different ones of the regions of the render output, so that the allocation of the regions to the rendering processors 12, 13 can allow the processing to be carried out for the generation of the render output efficiently by the rendering processors 12, 13. Operations of the graphics processor 3 to determine an amount of processing expected to be required to be performed to process different ones of the regions of the render output will now be described in more detail.

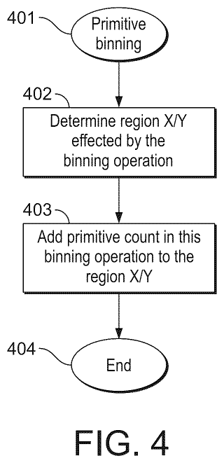

FIG. 4 shows the relevant operation of the graphics processor 3 in accordance with embodiments of the technology described herein where an amount of processing expected to be required to be performed to process different ones of the regions of the render output is based on a number of primitives to be processed for different ones of the regions of the render output.

The operation shown in FIG. 4 begins when the tiling unit 21 is performing a binning operation (step 401) for a region of a render output when preparing binning data structure(s) 19 to be used to identify the (visible, non-culled) primitives that should be rendered for regions to be rendered to generate the render output.

In the binning operation, data indicative of a number of primitives being identified as being for (e.g. covering) a region is stored in preparation of the binning data structure(s) 19. However, in addition to using the binning operation in the preparation of the binning data structure(s) 19, the geometry processor 11 determines which region is being effected by the binning operation (step 402) (e.g. based on an X and Y co-ordinate location for the region in question), and stores a count of the number of primitives indicated as being for the region in the binning operation to a data position in the region processing buffer 28 for the region (step 403). The relevant operation in relation to the binning operation in question is then completed (step 404) and another binning operation can be carried out, and the steps repeated accordingly, until all of the required binning operations for a render output have been completed and the binning data structure(s) 19 for the render output have finished being prepared.

When the tiling unit 21 has completed the binning operations for a render output, the region processing buffer 28 stores an indication of the number of primitives to be processed for the different regions of the render output, and the expected processing determining circuit 27 can determine an amount of processing expected to be required to be performed to process different ones of the regions of a render output based on the data stored in the region processing buffer 28. The allocation of different ones of the regions to the rendering processors 12, 13 for processing can then be controlled based on the determined amount of processing expected to be required to be performed to process different ones of the regions.

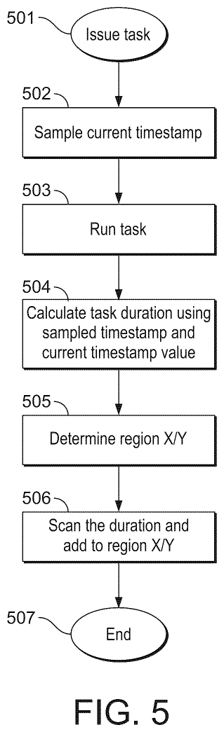

FIG. 5 shows the relevant operation of the graphics processor 3 in accordance with embodiments of the technology described herein where an amount of processing expected to be required to be performed to process different ones of the regions of a render output is based on an amount of processing time used to process respective regions of one or more other render outputs.

The operation shown in FIG. 5 begins when the region allocator 24 issues a rendering task to a rendering processor 12, 13 (step 501) for processing. In response to being issued the rendering task, the rendering processor 12, 13 samples a current timestamp of the processing time tracking circuit 29 (step 502) to determine a task start time and processes the rendering task (step 503) to thereby render a region of a render output that the rendering task corresponds to. Upon completing the processing of the rendering task (e.g. by rendered data for the region corresponding to the task being written out of the tile buffer 22), the rendering processor 12, 13 samples a current timestamp of the processing time tracking circuit 29 again to determine a task end time and calculates a processing duration for the rendering task based on the task start time and the task end time (step 504). A processing duration for a task may, in embodiments, be determined in any other suitable manner, such as by clearing (“zeroing”) a counter when a task starts and stopping the counter when the task finishes.

With continued reference to FIG. 5, the rendering processor 12, 13 determines a location of the region corresponding to the rendering task within the render output (step 505) (e.g. an X and Y co-ordinate for the region), optionally scales the calculated processing duration to a size of the region, and stores an indication of the (scaled) processing duration to a data position in the region processing buffer 28 for the region (step 506), the data position being determined based on the determined location of the region within the render output.

The relevant operation in relation to the processing of the rendering task is then completed (step 507) and another rendering task may be issued to the rendering processor 12, 13 for processing as appropriate.

When all of the rendering tasks for a render output have been processed, the region processing buffer 28 stores an indication of the (scaled) processing duration for different regions of the render output, and the expected processing determining circuit 27 can determine an amount of processing expected to be required to be performed to process different ones of the regions of another (subsequently processed) render output based on the data stored in the region processing buffer 28. The allocation of different ones of the regions of another render output to be processed to the rendering processors 12, 13 for processing can then be controlled, based on the determined amount of processing expected to be required to be performed to process the regions of that render output.

In either case of using a processing time or number of primitives to determine an amount of processing expected to be required to be performed, the region processing buffer 28 may store data for a single render output at a time, or may store data for plural different render outputs concurrently. When an amount of processing expected to be required to be performed to process different ones of the regions of a render output has been determined based on the data stored in the region processing buffer 28, that data may then be cleared or overwritten with data for another render output. Otherwise, data for different render outputs may be combined (e.g. averaged) to give an updated amount of processing expected to be required for different regions of a render output (e.g. based on the processing durations for regions of plural consecutive render outputs).

Although in the embodiments of FIGS. 4 and 5 data for each of plural different regions of a render output can be stored in the region processing buffer 28 concurrently, this is not essential, and the region processing buffer 28 may otherwise, for example, store data indicating a region or regions for which a largest amount of processing is currently expected to be required (e.g. based on a longest processing duration being used for those regions) and this may be updated during the processing of a render output so that when the render output processing is completed the region processing buffer 28 can indicate the region or regions expected to require the most amount of processing.

Operations of the graphics processor 3 to control the allocation of regions of the render output to the rendering processors 12, 13 based on an amount of processing expected to be required to be performed to process different ones of the regions of the render output will now be described in more detail.

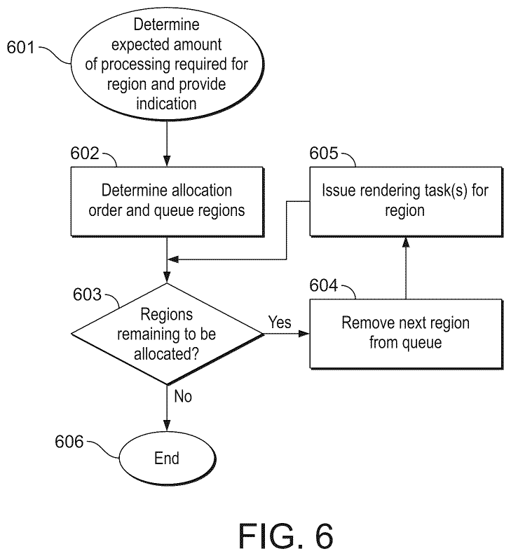

FIG. 6 shows the relevant operation of the graphics processor 3 in accordance with embodiments of the technology described herein where the order in which regions of a render output are allocated to the rendering processors 12, 13 for processing is controlled based on an amount of processing expected to be required to be performed to process different ones of the regions of the render output.

The operation shown in FIG. 6 begins when the expected processing determining circuit 27 reads data from the region processing buffer 28, determines an amount of processing expected to be required to process different ones of the regions of a render output, and provides an indication of the amount of processing expected to be required to be performed to process different ones of the regions of the render output to the allocation controller 26 (step 601). For example, the expected processing determining circuit 27 may directly provide data from the region processing buffer 28 as the indication. In another example, the expected processing determine circuit 27 may determine a ranking for each region (e.g. where each region is assigned a value indicating a “low”, “medium”, or “high” amount of processing is expected to be required for the region in question) and provide the determined rankings as the indication.

The allocation controller 26 determines an allocation order for the render output based on the indication of the amount of processing expected to be required to be performed to process different ones of the regions of the render output and queues regions of the render output to be allocated by the region allocator 24 to the rendering processors 12, 13 for processing according to the determined allocation order (step 602).

The region allocator 24 determines whether there are regions for a render output remaining to be allocated (step 603) and, when there are regions remaining to be allocated, the region allocator 24 removes the next region to be allocated from the queue (step 604) and issues one or more rendering tasks for the region to the rendering processor(s) 12, 13 allocated to process the region (605). Steps 603-605 are repeated until the region allocator 24 determines that there are no further regions to be allocated for a render output, at which point the allocation of regions for the render output is completed (step 606).

In the operation of FIG. 6, a single allocation order and queue of regions for a render output is provided, for example based on a single traversal path or pattern that traverses each region of the render output, and regions in the allocation order can in an embodiment be allocated to any of the rendering processors 12, 13 (e.g. depending on which rendering processor 12, 13 becomes available first for processing the region in question).

However, in other embodiments, plural allocation orders and queues of regions for a render output may be prepared, with different queues being maintained for different rendering processors or groups of rendering processors, and regions can be entered into one of the queues depending on which rendering processor or group of rendering processors is to process the region in question (e.g. where regions in different sections of a render output are to be processed by different rendering processors). In this case, steps 603-605 can be carried out for each of the queues until all regions of the render output have been allocated for processing.

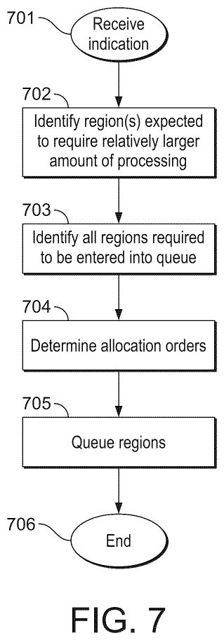

FIG. 7 shows the relevant operation of the graphics processor 3 in accordance with embodiments of the technology described herein where the allocation controller 26 determines an allocation order in which regions of a render output are allocated to the rendering processors 12, 13 for processing based on an amount of processing expected to be required to be performed to process different ones of the regions of the render output.

The operation shown in FIG. 7 begins when the allocation controller 26 receives an indication of an amount of processing expected to be required to be performed to process different ones of the regions of a render output (step 701).

The allocation controller 26 identifies, based on the indication, one or more regions of the render output that are expected to require a relatively larger amount of processing to be performed compared to other regions of the render output (step 702).

The allocation controller 26 also identifies all of the regions that are required to be entered into a queue of regions for the render output (step 703), for example based on a maximum and minimum value of co-ordinates indicative of locations within the render output that different regions to be entered into the queue can have.

The allocation controller 26 determines an allocation order for the render output (step 704). This may be carried out by determining a starting region of the render output to be entered into the queue first based on the identified one or more regions of the render output that are expected to require a relatively larger amount of processing, and setting a traversal path or pattern to be used for the queue. The traversal path or pattern to be used may be pre-determined or may be selected based (also), for example, on the identified one or more regions of the render output that are expected to require a relatively larger amount of processing.

The allocation controller 26 then queues regions for allocation by the region allocator 24 (step 705) according to the allocation order (e.g. according to the starting region and the traversal path or pattern set for the queue), until all of the regions identified as requiring entry into the queue have been entered, at which point the preparation of the queue is completed (step 706).

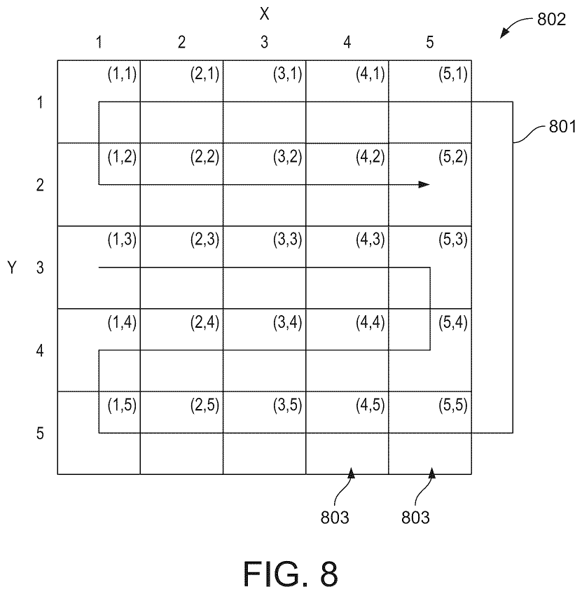

FIG. 8 shows a traversal path 801 for a render output 802 in accordance with an embodiment of the technology described herein.

In FIG. 8, the render output 802 is divided into 5×5 regions 803 for allocation purposes, with each region having a location in the render output 802 defined by co-ordinates (X, Y) where each of X and Y take values from 1 to 5. Regions (3,3), (3,4), (3, 4) and (4,4) are each determined to have a relatively larger amount of processing expected to be required to be performed compared to the other regions of the render output 802. In FIG. 8, the traversal path 801 is set to be a serpentine path and, based on the locations of the regions determined to have a relatively larger amount of processing expected to be required to be performed, region (1,3) is selected as the starting region. For example, the graphics processor 3 may be configured such that only regions having an X co-ordinate value of 1 may be able to be selected to be a starting region, and region (1, 3) may be selected based on it having the lowest value of the Y co-ordinate also shared by a region determined to have a relatively larger amount of processing expected to be required. Accordingly, the traversal path 801 takes the form of a serpentine path that begins at region (3,1) and continues until reaching the end of the final row at region (5,5), upon which the traversal path 801 loops back to the top row and continues from region (5,1) until finishing at region (5,2).

By allocating the regions 803 in an order according to traversal path 801, the regions determined to have a relatively larger amount of processing expected to be required to be performed are allocated relatively earlier in the allocation order compared to possible alternative traversal paths, such as if a serpentine path was used beginning with region (1,1).

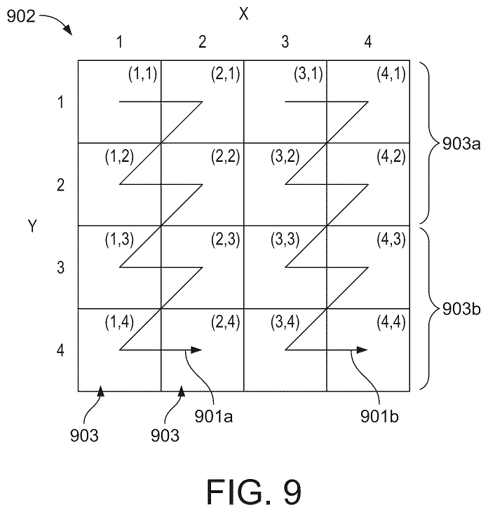

FIG. 9 shows two traversal paths 901a, 901b for a render output 902 in accordance with an embodiment of the technology described herein.

In FIG. 9, the render output 902 is divided into 4×4 regions 903 for allocation purposes (however, any other number or configuration of regions may be used), with each region having a location in the render output 802 defined by co-ordinates (X, Y) where each of X and Y take values from 1 to 4. The regions 903a in the top half of the render output 902 (the regions with a Y co-ordinate value of 1 or 2) are determined to have a relatively larger amount of processing expected to be required to be performed compared to the regions 903b in the bottom half of the render output 902 (the regions with a Y-coordinate value of 3 or 4). Based on the locations of the regions determined to have a relatively larger amount of processing expected to be required to be performed, region (1,1) is selected to be used as the starting region for traversal path 901a and region (3,1) is selected to be used as the starting region for traversal path 901b, where traversal paths 901a and 901b each follow Morton-order (“Z-order”) for two respective columns of the render output 902, with traversal path 901a traversing regions having an X co-ordinate value of 1 or 2, and traversal path 901b traversing regions having an X co-ordinate value of 3 or 4. The regions traversed by traversal path 901a can be allocated in an order according to the traversal path 901a to one rendering processor 11, 12, and the regions traversed by traversal path 901b can be allocated in an order according to the traversal path 901b to another rendering processor 11, 12.

Allocating the regions 903 according to traversal paths 901a and 901b can distribute the regions 903a determined to have a relatively larger amount of processing expected to be required to be performed evenly between two rendering processors 11, 12, and the regions 903a determined to have a relatively larger amount of processing expected to be required to be performed are allocated relatively earlier in the allocation order for each rendering processor 11, 12 compared to possible alternative traversal paths.

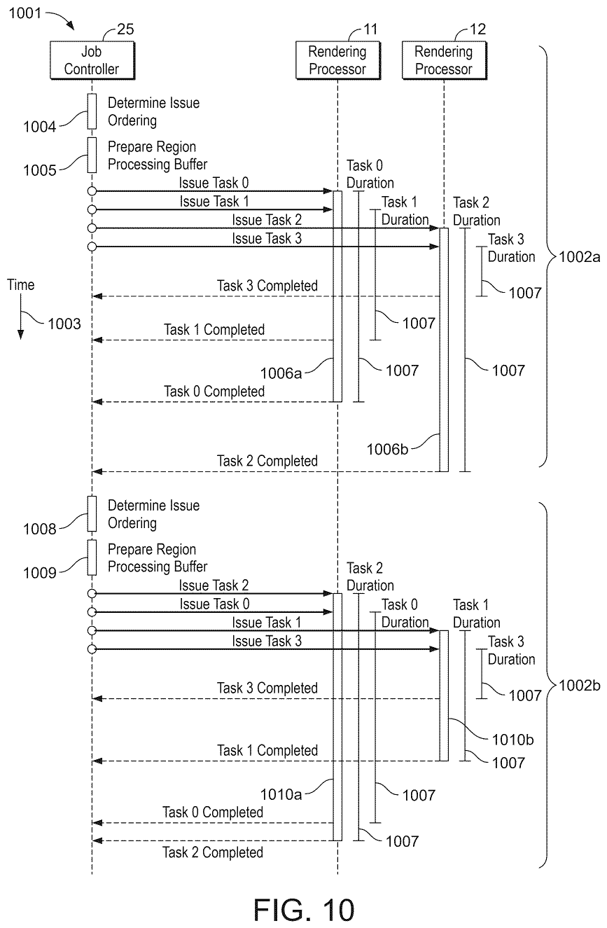

FIG. 10 shows a processing timeline 1001 for the graphics processor 3 in accordance with an embodiment of the technology described herein.

The processing timeline 1001 shows operations of the job controller 25 and the two rendering processors 11, 12 for processing two render outputs that are each divided into 4 regions for allocation purposes. Operations 1002a for a first of the two render outputs are carried out before operations 1002b for a second of the two render outputs. Regions for the second render output are allocated to the rendering processors for processing 11, 12 based on an amount of processing time used by the rendering processors 11, 12 to process the regions of the first render output.

In the processing timeline 1001, time proceeds in direction 1003. The processing timeline 1001 begins when the job controller determines an allocation order for the first render output (block 1004), and allocates data positions in the region processing buffer 28 for storing processing durations used to process different ones of the regions of the first render output (block 1005). In the present embodiment, the 4 regions of the first render output are denoted as region 0, region 1, region 2, and region 3 respectively, and there are 4 rendering tasks to be issued denoted rendering task 0, rendering task 1, rendering task 2 and rendering task 3, where rendering task 0 corresponds to region 0, rendering task 1 corresponds to region 1, rendering task 2 corresponds to region 2, and rendering task 3 corresponds to region 3. The allocation order determined for the first render output is to allocate region 0, followed by region 1, followed by region 2, followed by region 3. Accordingly, the job controller 25 issues rendering task 0 for processing, followed by rendering task 1, followed by rendering task 2, followed by rendering task 3. Each of the rendering processors 11, 12 can (in the present embodiment) process two rendering tasks concurrently. One rendering processor 11 is allocated rendering task 0 and rendering task 1 and performs rendering operations (block 1006a) to process the two rendering tasks it is issued. The other rendering processor 12 is allocated rendering task 2 and rendering task 3 and performs rendering operations (block 1006b) to process the two rendering tasks. The rendering processors 12, 13 track an amount of processing time 10007 used to process each of the respective rendering tasks and, when the processing of a rendering task is completed, stores an indication of a processing duration for the rendering task in a data position within the region processing buffer 28 for the region that the rendering task corresponds to.

When the operations 1002a for the first render output are completed, the operations 1002b for the second render output are begun, starting with the job controller determining an allocation order for the second render output (block 1008) based on data stored in the region processing buffer 28 for the first render output. The four regions of the second render output are denoted in the same manner as for the first render output, and there are four rendering tasks for the regions also denoted in the same manner as for the first render output, where regions denoted in the same manner for the first and second render outputs represent corresponding locations in the two render outputs.

In the present embodiment, the allocation order determined for the second render output corresponds to a descending order of the processing durations used to process the corresponding regions of the first render output, and according to this order region 2 of the first render output had the longest processing duration and so region 2 of the second render output is to be allocated first, region 0 of the first render output had the next longest processing duration and so region 0 of the second render output is to be allocated second, region 1 of the first render output had the next longest processing duration and so region 1 of the second render output is to be allocated third, and region 3 of the first render output had the next longest processing duration and so region 3 of the second render output is to be allocated fourth.

After the allocation order is determined for the second render output, the job controller 25 allocates data positions in the region processing buffer 28 for storing processing durations used to process different ones of the regions of the second render output (block 1009). The job controller 25 then proceeds to issue the rendering tasks for the second render output to the rendering processors according to the determined allocation order. Rendering task 2 and rendering task 0 are allocated to one rendering processor 11 that performs rendering operations (block 1010a) to process the rendering tasks it is allocated, and rendering task 1 and rendering task 2 are allocated to the other rendering processor 12 that performs rendering operations (block 1010b) to process the rendering tasks it is allocated. As with the first render output, the rendering processors 12, 13 track an amount of processing time 10007 used to process each of the respective rendering tasks and, when the processing of a rendering task is completed, stores an indication of a processing duration for the rendering task in a data position within the region processing buffer 28 for the region that the rendering task corresponds to.

The processing durations 1007 for the rendering tasks of the second render output are in a same order as for the first render output, such that rendering task 2 is allocated first and has the longest processing duration, rendering task 0 is allocated second and has the next longest processing duration, rendering task 1 is allocated third and has the next longest processing duration, and rendering task 3 is allocated fourth and has the next longest processing duration. As the rendering tasks with relatively longer processing durations are allocated relatively earlier in the allocation order, the processing of the second render output is completed in less time compared to what would be required if rendering tasks with relatively longer processing durations were allocated relatively later in the allocation order.

It can be seen from the above that the technology described herein, in its embodiments at least, can provide more efficient processing of a render output (e.g. in terms of lower latencies, greater spatial coherency, less data bandwidth requirement, higher throughput, lower energy consumption) by rendering processors when performing graphics processing. This is achieved in the embodiments of the technology described herein at least, by controlling the allocation of regions of a render output to rendering processors based on an amount of processing expected to be required to be performed to process different ones of the regions of the render output.

Although embodiments of the technology described herein have been described relating to performing graphics processing to render a render output, the technology described herein is also applicable more generally to processing a data array that is divided into a plurality of regions for allocation to processing circuits for processing, where the allocation of the regions to the processing circuits is controlled based on an amount of processing expected to be required to be performed to process different ones of the regions of the data array.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of operating a graphics processor that comprises plural rendering processors each operable to render one or more regions that a render output is divided into for allocation to the rendering processors, the method comprising:
when rendering a render output that is divided into a plurality of regions for allocation to rendering processors for processing, controlling the allocation of the regions to the rendering processors based on an amount of processing expected to be required to be performed to process different ones of the regions of the render output.

2. The method of claim 1, wherein the order in which regions of the render output are allocated to the rendering processors for processing is controlled based on an amount of processing expected to be required to be performed to process different ones of the regions of the render output.

3. The method of claim 2, wherein controlling the order in which regions of the render output are allocated to the rendering processors for processing based on an amount of processing expected to be required to be performed to process different ones of the regions of the render output comprises:
controlling the order in which regions of the render output are allocated to the rendering processors for processing such that a rendering processor is allocated a region or regions expected to require relatively larger amounts of processing before being allocated a region or regions expected to require relatively smaller amounts of processing.

4. The method of claim 1, wherein the allocation of regions of a render output to the rendering processors for processing is controlled based on an amount of processing expected to be required to be performed to process different ones of the regions of the render output and based on the locations of the regions within the render output.

5. The method of claim 4, wherein controlling allocation of regions of a render output to the rendering processors for processing comprises:
selecting the region of a render output that a rendering processor is allocated to process first based on an amount of processing expected to be required to be performed to process different ones of the regions of the render output; and
selecting the order in which one or more other regions of the render output are allocated to the rendering processors for processing based on the locations of the one or more other regions within the render output.

6. The method of claim 1, comprising determining an amount of processing expected to be required to be performed to process different ones of the regions of a render output based on one or more of:
commands that have been generated for the processing of the different regions by the rendering processors; and
data that has been generated for the processing of the different regions by the rendering processors.

7. The method of claim 1, comprising determining an amount of processing expected to be required to be performed to process different ones of the regions of a render output based on a number of graphics primitives to be processed for the different regions of the render output.

8. The method of claim 1, comprising determining an amount of processing expected to be required to be performed to process different ones of the regions of a render output based on one or more of:
which regions are expected to represent different content to one another; and
a determined display orientation for the render output.

9. The method of claim 1, comprising determining an amount of processing expected to be required to be performed to process different ones of the regions of a render output based on an amount of processing performed to process different regions of one or more other render outputs.

10. The method of claim 9, wherein an amount of processing performed to process different ones of the regions of one or more other render outputs is based on an amount of processing time used to process the different regions of the one or more other render outputs.

11. The method of claim 1, wherein the graphics processor comprises rendering processors having different processing capabilities to one another, and which rendering processor or rendering processors a region of the render output is allocated to is controlled based on an amount of processing expected to be required to be performed to process the region and on the different processing capabilities of the rendering processors.

12. A graphics processor, comprising:
a plurality of rendering processors, each operable to render one or more regions that a render output is divided into for allocation to the rendering processors;
a region allocation circuit configured to allocate regions of a render output to be processed to rendering processors for processing; and
an allocation controlling circuit configured to control the allocation of regions of the render output to the rendering processors for processing based on an amount of processing expected to be required to be performed to process different ones of the regions of the render output.

13. The graphics processor of claim 12, wherein the allocation controlling circuit is configured to control the order in which regions of the render output are allocated to the rendering processors for processing based on an amount of processing expected to be required to be performed to process different ones of the regions of the render output.

14. The graphics processor of claim 13, wherein the allocation controlling circuit is configured to control the order in which regions of the render output are allocated to the rendering processors for processing such that a rendering processor is allocated a region or regions expected to require relatively larger amounts of processing before being allocated a region or regions expected to require relatively smaller amounts of processing.

15. The graphics processor of claim 12, wherein the allocation controlling circuit is configured to control the allocation of regions of the render output to the rendering processors for processing based on an amount of processing expected to be required to be performed to process different ones of the regions of the render output and based on the locations of the regions within the render output.

16. The graphics processor of claim 12, wherein the graphics processor comprises an expected processing determining circuit configured to determine an amount of processing expected to be required to be performed by the rendering processors to process different ones of the regions of a render output, and to provide an indication of an amount of processing expected to be required to be performed by the rendering processors to process the different ones of the regions of a render output to the allocation controlling circuit.

17. The graphics processor of claim 16, wherein the expected processing determining circuit is configured to determine an amount of processing expected to be required to be performed by the rendering processors to process different ones of the regions of a render output based on one or more of:
commands that have been generated for the processing of the different regions by the rendering processors;
data that has been generated for the processing of the different regions by the rendering processors;
a number of graphics primitives to be processed for the different regions of the render output;
which regions are expected to represent different content to one another; and
a determined display orientation for the render output.

18. The graphics processor of claim 16, wherein the expected processing determining circuit is configured to determine an amount of processing expected to be required to be performed by the rendering processors to process different ones of the regions of a render output based on an amount of processing performed to process different regions of one or more other render outputs.

19. The graphics processor of claim 18, wherein:
the graphics processor comprises one or more processing time tracking circuits configured to track an amount of processing time used to process different regions of a render output; and
the expected processing determining circuit is configured to determine an amount of processing expected to be required to be performed to process different regions of a render output based on an amount of processing time tracked by the one or more processing time tracking circuits for different regions of one or more other render outputs.

20. A non-transitory computer-readable storage medium storing computer software code that when executing on one or more processors performs a method of operating a graphics processor that comprises plural rendering processors each operable to render one or more regions that a render output is divided into for allocation to the rendering processors, the method comprising:
when rendering a render output that is divided into a plurality of regions for allocation to rendering processors for processing, controlling the allocation of the regions to the rendering processors based on an amount of processing expected to be required to be performed to process different ones of the regions of the render output.
